(19) United States
(12) Patent Application Publication
(10) Pub. No.: US 2016/0179081 A1
(43) Pub. Date: Jun. 23, 2016

(54) Optimized Production Scheduling Using Buffer Control and Genetic Algorithm

(71) Applicant: Siemens Aktiengesellschaft, Munich (DE)

(72) Inventors: Zeyi Sun, Plainsboro, NJ (US); Dong Wei, Edison, NJ (US); Lingyun Wang, Princeton, NJ (US)

(21) Appl. No.: 14/659,880

(22) Filed: Mar. 17, 2015

Related U.S. Application Data
(60) Provisional application No. 62/095,118, filed on Dec. 22, 2014.

(51) Int. Cl. G05B 19/4069; G05B 19/408

(52) U.S. Cl. CPC G05B 19/4069; G05B 19/408; G05B 2219/32337

(57) ABSTRACT

A method for optimizing production scheduling in a manufacturing plant. The method includes providing a baseline model of the plant to obtain energy and production performance of each station in the plant. The method also includes providing a buffer control scheme that generates optimal buffer threshold values. The control scheme utilizes a genetic algorithm having first and second fitness functions each including a penalty for violating a production throughput constraint. Further, the method includes generating a final production schedule by utilizing a genetic algorithm having third and fourth fitness functions each having a penalty for violating an extreme buffer utilization policy. The genetic algorithm also includes fifth and sixth fitness functions that include a penalty for violating an empirical buffer utilization policy. The first, third and fifth fitness functions include objectives for minimizing electricity consumption and the second, fourth and sixth fitness functions include objectives for minimizing electricity cost.

### CROSS REFERENCE TO RELATED APPLICATION

This application claims the benefit under 35 U.S.C. §119(e) of U.S. Provisional Application No. 62/095,118 entitled ENERGY-BASED SMART SCHEDULING FOR PRODUCTION LINES BY USING BUFFER CONTROL AND GENETIC ALGORITHMS, filed on Dec. 22, 2014, Attorney Docket No. 2014P22524US, which is incorporated herein by reference in its entirety and to which this application claims the benefit of priority.

### FIELD OF THE INVENTION

The present invention relates to the simulation of production scheduling, and more particularly, to a method for providing optimized production scheduling by optimizing electricity consumption and cost by using a genetic algorithm and buffer control.

### BACKGROUND OF THE INVENTION

A production schedule used by a manufacturing plant plays a critical role in daily operation. Traditionally, the industrial sector has focused more on productivity, quality and timely delivery to the customer whereas energy related measures such as energy consumption and energy cost had a lesser focus. Recently, with the rising awareness of environmental concerns and energy costs, more environment-related key performance indexes (KPIs) are being used to evaluate the performance of a production operation.

Many industrial facilities utilize an industrial energy management system. Such systems focus on the measurement, monitoring, visualization and KPI evaluation of the energy related measures. However, current systems are merely information platforms that organize data in a preliminary way.

### SUMMARY OF INVENTION

A method is disclosed for optimizing production scheduling in a manufacturing plant having a plurality of stations and buffers. The method includes providing a baseline simulation model of the manufacturing plant to obtain energy and production performance of each station. The method also includes providing a buffer based control scheme that generates at least one optimal buffer threshold value and a first production schedule. In particular, the buffer based control scheme utilizes a genetic algorithm having first and second fitness functions each including a penalty for violating a production throughput constraint. In addition, the first fitness function includes an electricity consumption minimization objective and the second fitness function includes an electricity cost minimization objective. Further, the method includes generating a final production schedule by utilizing a genetic algorithm having third and fourth fitness functions each having a penalty for violating an extreme buffer utilization policy and the penalty for violating the production throughput constraint. In addition, the genetic algorithm includes fifth and sixth fitness functions each having a penalty for violating an empirical buffer utilization policy and the penalty for violating the production throughput constraint. Further, the third and fifth fitness functions each include the electricity consumption minimization objective and the fourth and sixth fitness functions each include the electricity cost minimization objective.

Those skilled in the art may apply the respective features of the present invention jointly or severally in any combination or sub-combination.

### BRIEF DESCRIPTION OF DRAWINGS

The teachings of the present invention can be readily understood by considering the following detailed description in conjunction with the accompanying drawings, in which:

FIG. 1 depicts a flowchart for an exemplary manufacturing system having a production flow for manufacturing a product in a manufacturing plant.

FIG. 2 is depicts a flowchart for a method for providing optimized production scheduling by optimizing electricity consumption and cost.

FIG. 3 is a schematic of an auto part manufacturing system used for a case study for illustrating the current invention.

FIG. 4 is a depiction of a baseline simulation model generated by Tecnomatix® Plant Simulation software available from Siemens.

FIG. 5 is a high level block diagram of a computer.

To facilitate understanding, identical reference numerals have been used, where possible, to designate identical elements that are common to the figures.

### DETAILED DESCRIPTION

Although various embodiments that incorporate the teachings of the present invention have been shown and described in detail herein, those skilled in the art can readily devise many other varied embodiments that still incorporate these teachings. The invention is not limited in its application to the exemplary embodiment details of construction and the arrangement of components set forth in the description or illustrated in the drawings. The invention is capable of other embodiments and of being practiced or of being carried out in various ways, Also, it is to be understood that the phraseology and terminology used herein is for the purpose of description and should not be regarded as limiting. The use of “including,” “comprising,” or “having” and variations thereof herein is meant to encompass the items :listed thereafter and equivalents thereof as well as additional items.

In the following description, Section 1 describes a simulation-based energy-integrated production scheduling for an industrial or manufacturing plant. Section 2 presents a case study based on an auto part manufacturing plant to illustrate the current invention.

Section 1

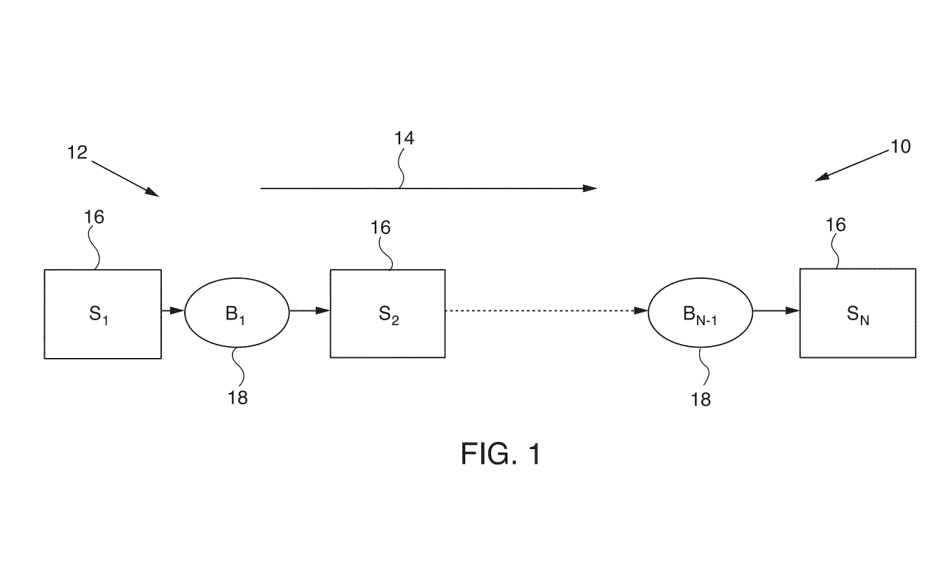

Referring to FIG. 1, a flowchart 10 is shown of an exemplary manufacturing system 12 having a production flow 14 for manufacturing a product (i.e. production output) in a manufacturing plant. The manufacturing system 12 includes a plurality of manufacturing stations 16 (denoted by S₁, S₂, . . . S_{N}) and buffers 18 (denoted by B_{1,} . . . B_{N-1}). The stations 16 may each be configured to manufacture a part or a portion of a part (i.e. a work-in-process part) used in a product. The buffers 18 serve to store at least one work-in-process part to be processed at a downstream station 14. For example, one or more of the stations 16 may experience a failure during operation that halts production of a work-in-process part. A work-in-process part stored in a buffer 18 may then be used to maintain production output in case there is failure at an upstream station 16 or other production disruption.

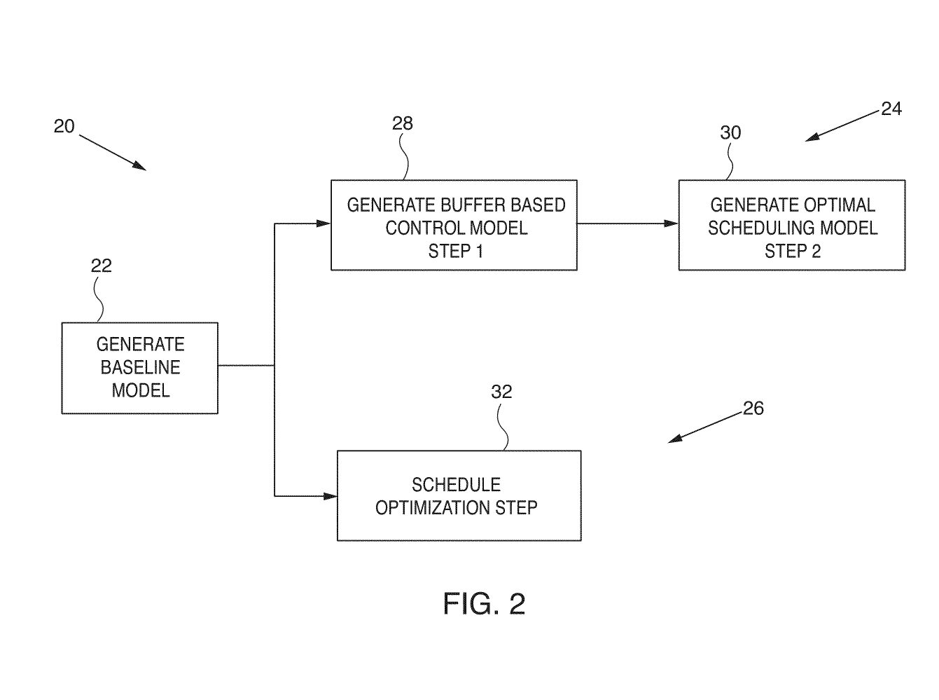

A method 20 for providing optimized production scheduling by optimizing electricity consumption and cost in accordance with the invention is shown in FIG. 2. The method 20 includes generating a baseline simulation model 22 of the manufacturing plant followed by using either a two-step model 24 or a one-step model 26. The two step model 24 includes generating a buffer based control model or scheme 28 (step 1 as will be described) and an optimal scheduling model 30 (step 2 as will be described). Users may select either minimum energy consumption or minimum energy cost as a preferred objective. For example, it is possible that, on a winter day, the electricity consumption rate is flat and no power demand charge is assessed by an electrical utility. Therefore, the objective of electricity consumption minimization is an appropriate choice, In contrast, it is possible that, on a summer day, the electricity rate is variable and demand charge is also included, in the tariff, and thus the objective of minimum electricity cost is an appropriate choice. Alternatively, the baseline model 22 is followed by the one-step model 26 that includes a schedule optimization step 32 as will be described.

The baseline model 22 of the plant may be generated by using known simulation software for manufacturing plants. In an embodiment, Tecnomatix® Plant Simulation computer software available from Siemens may be used. Parameters for the stations 16 and buffers 18, e.g., production rate, energy consumption profile, buffer capacity, and labor factor are incorporated into the baseline model 22. The material flow logics are also defined in the baseline model 22. Both energy consumption-related and productivity-related measures may be obtained with the baseline model 22.

After the baseline model 22 is generated, steps 1 and 2 are implemented to assist a manufacturer in identifying an optimal energy-integrated production schedule. In step 1, the buffer-based dynamic control model 28 or scheme 28 is used to generate a first optimized production schedule for the manufacturing system 12 based on a selected time interval used. as a scheduling unit. In an embodiment, the time interval may be equivalent to a duration used by an electric utility to calculate a power demand charge. By way of example, the selected time interval is approximately 15 minutes. In step 1, a production level or output of each station 16 is controlled based on a buffer level (i.e. number of parts available in a buffer) of adjacent buffers 18. In particular, production output for a station 16 is temporarily reduced or stopped when an upstream buffer 18 is close to empty or a downstream buffer 18 is close to full, while maintaining production output when an upstream buffer 18 is dose to full or a downstream buffer 18 is close to empty.

In order to avoid a circumstance wherein a station 16 receives potentially contradictory control actions (e.g., when both upstream and downstream buffers 18 are close to empty), the following rules are applied for the buffers 18 depending on the location of the stations 16. For an ending station 16 or stations 16 with a downstream buffer 18 that relates to some delivery activity, e.g., shipment for outsourced processing (denoted as type I stations 16), the buffer level of an adjacent upstream buffer 18 and the required delivery condition (e.g., final throughput, delivery for some outsourced processes) are jointly used for decision-making.

For the remaining stations 16 (denoted as type II stations 16), adjacent downstream buffers 18 are used for decision-making. in particular, it is desirable to reduce production when a downstream buffer 18 is close to full or full. Specifically, a set of threshold values for a buffer level ratio (i.e., a ratio of a buffer level to a buffer capacity of a buffer 18) is defined to determine the control actions for the stations 16. In an embodiment, the range of threshold values for a buffer 18 for controlling an upstream station 16 is set to be between approximately 0.5 and 1.0 (i.e. the downstream buffer 18 is approximately half-full to full) in order to reduce or stop production output of the upstream station 16 when the downstream buffer 18 is close to full or full as previously described.

Further, it is desirable to reduce production when an upstream buffer 18 is close to empty or empty. In an embodiment, the range of threshold values for a buffer 18 for controlling a downstream station 16 is set to be between approximately 0 and 0.5 in order to reduce or stop production output of the downstream station 16 when an upstream buffer 14 is close to empty or empty. For a type I station 16, production will not be stopped unless the delivery condition is satisfied and the upstream buffer level is lower than a threshold value. For a type II station 16, production will be stopped if the downstream buffer level is higher than the threshold value.

A known genetic algorithm (GA) may be used to find optimal threshold values and a corresponding first production schedule based on an exemplary 15 minute time interval basis as previously described. A GA may be implemented as a computer simulation that uses techniques inspired by natural evolution, such as inheritance, mutation, selection, and crossover. In a GA, a population of candidate solutions to an optimization problem is evolved toward better solutions. In particular, each candidate solution has a set of properties which may be mutated and altered. The evolution of the population is an iterative process wherein each iteration is known as a generation. Each candidate solution of each generation is evaluated by a fitness function. The more fit candidate solutions may be stochastically selected from a current population, and each candidate solution is modified (for example, recombined and possibly randomly mutated) to form a new generation of candidate solutions. The new generation of candidate solutions is then used in the next iteration of the algorithm. The GA may terminate when either a maximum number of generations has been produced, or a satisfactory fitness level has been reached for the population. In an embodiment, a GA capability provided in manufacturing plant simulation software such as Tecnomatix® Plant Simulation software available from Siemens may be used.

In accordance with the invention, fitness functions used in the GA may be based on different objectives. In particular, the objectives are either electricity consumption minimization (energy-oriented) or electricity cost minimization (cost-oriented). The fitness functions also include constraints that are applicable to a manufacturing application. For example, a constraint may be that a predetermined level of production output should be maintained and/or that a buffer level for the buffers 18 should be maintained within a certain range. The fitness functions for the objectives may be formulated as set forth in equations (1) and (2):

Fitness (E-O/S1)=Total Consumption+Penalty (TP) (1)

Fitness (C-O/S1)=Total Cost+Penalty (TP) (2)

Where notations E-O denotes energy-oriented, C-O denotes cost-oriented and S1 denotes step 1 of the model, It is desirable to minimize Total Consumption (i.e. total electricity consumption) and Total Cost (i.e. total electricity cost). Penalty (TP) is a penalty term that sets forth a potential penalty that will be incurred if a manufacturing throughput constraint is violated by a candidate solution for a threshold value. in an embodiment, the Penalty (TP) is approximately zero if a candidate solution is feasible. Alternatively, the Penalty (TP) is a very large positive real number if the candidate solution is not feasible since the objective is minimization. Total consumption may be generated by a simulation model based on the input power profiles of the machines used in the manufacturing system 12. Total cost may also be calculated based on the generated consumption data and given electricity billing rates of the simulation model. After running the GA in manufacturing plant simulation software such as Tecnomatix® Plant Simulation software available from Siemens, optimal threshold values and corresponding first production schedule are obtained.

In step 2, the first production schedule obtained in Step 1 will be used as the initial solution for further optimization using a GA in order to obtain a final or optimal production schedule. Due to variations in buffer levels after implementation of the algorithm, at least two different polices regarding buffer utilization are also considered. A first policy regarding buffer utilization is for extreme circumstances wherein a buffer level may vary from zero to full capacity and no preferred range is imposed (denoted as extreme policy). The second policy regarding buffer utilization is a more conservative configuration based on empirical data of the plant (denoted as empirical policy). In particular, the second policy is based on having a minimum number of parts available in a buffer and/or a maximum number of parts available, e.g. a range of safety stock, wherein the range is narrower than the range under the extreme policy. The empirical policy requires that the buffer level at the end of a scheduling horizon he maintained in the empirical range. The fitness functions used in the GA in step 2 considering two different buffer policies and two different objectives can be formulated as set forth in equations (3) to (6):

Fitness (E-O/EX/S2)=Total Consumption+Penalty (TP)+Penalty (EX Buffer) (3)

Fitness (E-O/EM/S2)=Total Consumption+Penalty (TP)+Penalty (EM Buffer) (4)

Fitness(C-O/EX/S2)=Total Cost+Penalty (TP)+Penalty (EX Buffer) (5)

Fitness(C-O/EM/S2)=Total Cost+Penalty (TP)+Penalty (EM Buffer) (6)

where EX denotes extreme buffer policy, EM denotes empirical buffer policy and S2 denotes step 2 of the algorithm. Penalty (EX Buffer) and Penalty (EM Buffer) denote the potential penalty that will be incurred if the constraint of the buffer level at the end of planning horizon is violated by the candidate solution considering the extreme policy and empirical policy, respectively, E-O, C-O, Total Consumption, Total Cost and Penalty (TP) are previously described. The final production schedule is then obtained by running a suitable GA.

In an alternate embodiment, the baseline model 22 is followed by the one-step model 26 that includes the schedule optimization step 32 as shown in FIG. 2. In this step, a GA is used to obtain an optimal production schedule that is directly based on the routing schedule of the baseline model 22. Similarly, two different objective functions combined with two different buffer level maintaining policies are considered. The fitness functions used in the GA are set forth in equations (7) to (10):

Fitness (E-O/EX)=Total Consumption+Penalty (TP)+Penalty (EX Buffer) (7)

Fitness (E-O/EM)=Total Consumption+Penalty (TP)+Penalty (EM Buffer) (8)

Fitness (C-O/EX)=Total Cost+Penalty (TP)+Penalty (EX Buffer) (9)

Fitness (C-O/EM)=Total Cost+Penalty (TP)+Penalty (EM Buffer) (10)

where E-O, C-O, Total Consumption, Total Cost, Penalty (TP), EX, EM, Penalty (EX Buffer) and Penalty (EM Buffer) are previously described.

### Section 2 Case Study

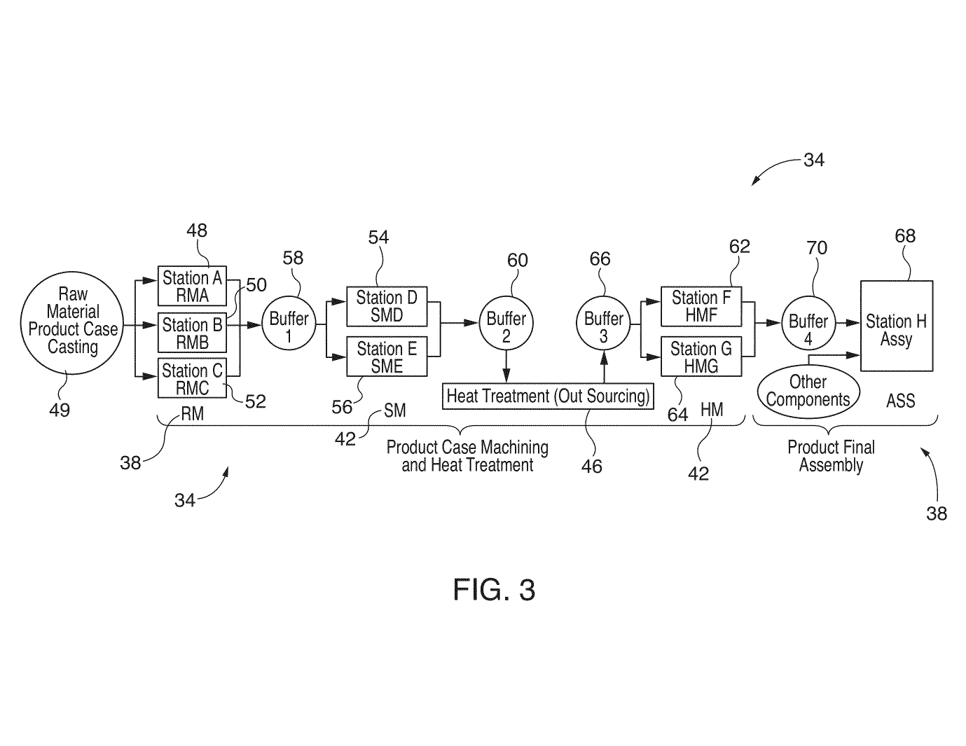

In order to illustrate the decision-making method of the current invention, a case study of an actual auto part manufacturing plant for the two-step model 24 and the one-step model 26 will now be described. An 8-hour shift is examined, Referring to FIG. 3, a schematic of an auto part manufacturing system 34 and associated processes for the case study is shown. The manufacturing system 34 includes both machining 34 and assembly 36 processes, The machining process 34 includes three different process stages defined as RM 38, SM 42, and HM 42. A heat treatment process 46 that is performed between the SM 42 and HM 42 processes is outsourced. Three parallel machining stations defined as Station A 48, Station B 50, and Station C 52 are used to perform the RM process 38 (i.e. RMA 48, RMB 50, and RMC 52, respectively). Two parallel machining stations defined as Station D 54 and Station E 56 are used to perform the SM process 42 (i.e. SMD 54 and SME 56, respectively). A first buffer 58 (i.e. Buffer 1) is located between RMA 48, RMB 50, RMC 52 and SMD 54, SME 56, In addition, a second buffer 60 (i.e. Buffer 2) is located between SMD 54, SME 56 and the outsourced heat treatment process 46. Raw material of case casting 49 enters RMA 48, RMB 50, and RMC 52.

Two parallel machining stations defined as Station F 62 and Station G 64 are used to perform HM process 42 (i.e. HMF 62 and HMG 64, respectively). A third buffer 66 (i.e. Buffer 3) is located between the outsourced heat treatment process 46 and HMF 62, HMG 64. An assembly station defined as Station H 68 is used to perform an assembly process (i.e. ASSY 68). A fourth buffer 70 (i.e. Buffer 4) is located between HMF 62, HMG 64 and ASSY 68.

Each machining station includes several different computer numerical controlled (CNC) machines with different functionalities such as turning, grinding, and milling. In addition, other auxiliary machines such as a demagnetization machine, washing machine, and balance machine may also be included in certain stations, ASSY 68 includes several workplaces where operators can fulfill the assembly tasks using the parts after machining and other part materials.

Table I sets forth the parameters of each Buffer 1,2,3,4. Table II shows the production capacity of each process and the required production target in an 8-hour shift. It is noted that the RM process 38 is the slowest process in the system 12. The ASSY 68 and SM 42 processes are two fastest processes in the system 34. In addition, information regarding assumed electricity-billing cost is shown in Table III.

TABLE I
CAPACITY AND INITIAL CONTENT OF BUFFER

| | Raw | | | | |
|---|---|---|---|---|---|
| | Material | Buffer 1 | Buffer 2 | Buffer 3 | Buffer 4 |
| Initial contents | 500 | 100 | 500 | 400 | 800 |
| (units) | | | | | |
| Capacity | 900 | 900 | 1000 | 1000 | 800 |
| (units) | | | | | |

TABLE II
SHIFT CAPACITY AND DELIVERY

| | RM | SM | HT (Outsourced) | HM | ASSY |
|---|---|---|---|---|---|
| Capacity | 450 | 500 | 450 | 480 | 520 |
| (units/shift) | | | | | |
| Required delivery | | | 450 | | 450 |
| (units) | | | | | |

TABLE III
ELECTRICITY RATE

| | Electricity | Power |
|---|---|---|
| | Consumption Rate | Demand Rate |
| | ($/kWh) | ($/kWh) |
| Off peak period | 0.2 | 15 |
| (8:00AM-12:00PM) | | |
| Peak period | 0.35 | |
| (12:00PM-4:00PM) | | |

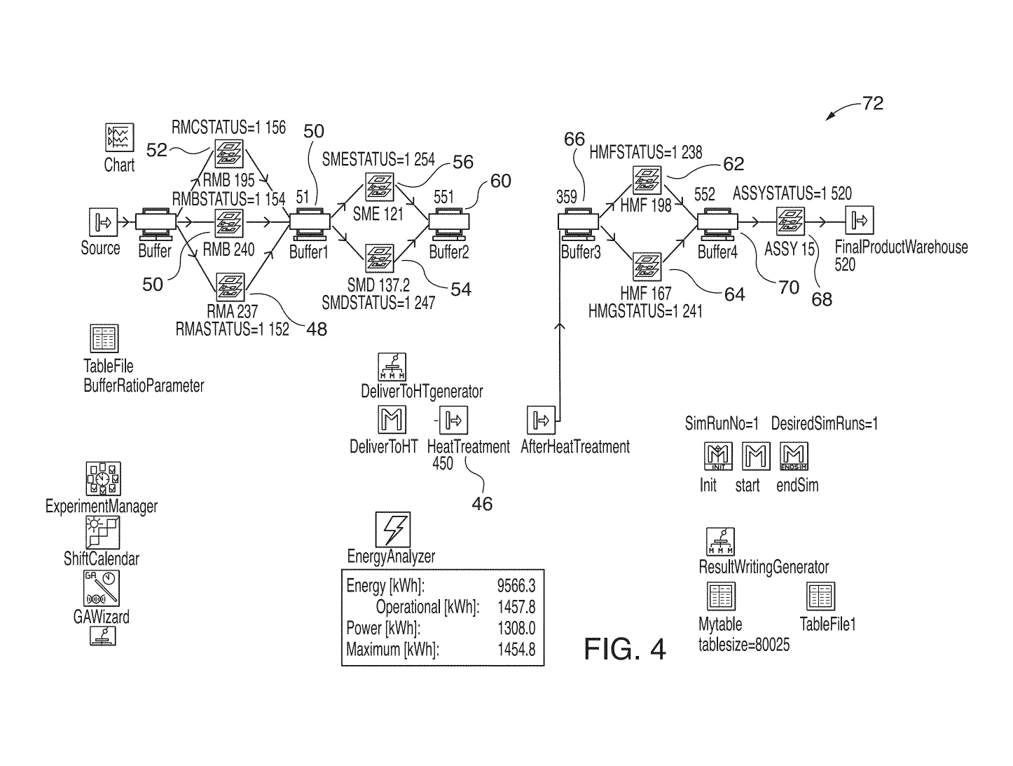

The baseline model 22 for the system 34 may be first established by manufacturing plant simulation software such as Tecnomatix® Plant Simulation software available from Siemens. Referring to FIG. 4, a depiction of a baseline simulation model 72 generated by the Tecnomatix® Plant Simulation software is shown. All the related parameters are defined in the baseline model 22. It was found that the results of the simulation using a routine operational strategy (maintain production of the entire system 34 throughout the 8-hour shift) substantially matches the actual performance regarding productivity and energy consumption provided by the auto part manufacturing plant used in the case study. Detailed information of the performance of the baseline model 22 regarding stations RMA 48, RMB 50, RMC 52, SMD 54, SME 56, HMF 62, HMG 64 and ASSY 66 is shown in Table IV.

TABLE IV
ENERGY & PRODUCTION PERFORMANCE
OF BASELINE MODEL

| | | | | | Total |
|---|---|---|---|---|---|
| | Total | Operational | Working | | Electricity |
| | Electricity | Electricity | Electricity | Production | per Part |
| Station | (kWh) | (kWh) | (kWh) | (parts) | (kWh/Part) |
| RMA | 1533 | 154.8 | 1378.2 | 153 | 10.02 |
| RMB | 1827.9 | 234 | 1593.9 | 154 | 11.87 |
| RMC | 1561.3 | 168.8 | 1392.5 | 156 | 10.01 |
| SMD | 1067.7 | 185.9 | 881.8 | 248 | 4.31 |
| SME | 792 | 131.3 | 660.7 | 255 | 3.11 |
| HMF | 1298.8 | 285.5 | 1013.3 | 238 | 5.46 |
| HMG | 1365.8 | 297.4 | 1068.4 | 242 | 5.64 |
| ASSY | 119.9 | 0.1 | 119.8 | 521 | 0.25 |
| Total | 9566.4 | 1457.8 | 8108.6 | Heat- | 450 |
| | | | | treatment | |
| Cost ($) | 23389.17 | | | | |

Based on the established baseline model, the two-step model 24 described in relation to FIG. 2 is carried out. In step 1, the initial threshold values and corresponding control policies that were used in the GA are shown in Table V. in an embodiment, the values were suggested by manufacturing plant personnel and are based on daily experience. The priority of ON/OFF control for the parallel stations is based on a comparison of electricity consumption per part production in Table IV. For example, for three RM stations, the electricity consumption per part can be ranked as RMC 52, RMA 48 and RMB 50 lowest to highest consumption per part. Therefore, RMB 50 has the highest priority to be turned off, followed by RMA 48 and RMC 52.

TABLE V
INITIAL THRESHOLD VALUE AND POLICY

| Pro- | | | | |
|---|---|---|---|---|
| cess | Buffer | Condition | Action | Notes |
| RM | Buffer 1 | Less than 67% | RMA, RMB, and RMC | |
| | | | are ON | |
| | | Between 67% | RMA and RMC are ON. | |
| | | and 83% | RMB is OFF | |
| | | Between 83% | RMC is ON. RMA and | |
| | | and 99% | RMB are OFF | |
| | | Larger than | RMA, RMB, and RMC | |
| | | 99% | are OFF | |
| SM | Buffer 2 | Less than 450 | SMD and SME are ON | Other- |
| | | | | wise, |
| | | | | check |
| | | | | Buffer 1 |
| | Buffer 1 | Less than 25% | SMD and SME are OFF | |
| | | Between 25% | SMD is OFF. SME is | |
| | | and 49% | ON | |
| | | Larger than | SMD and SME are ON | |
| | | 49% | | |
| HM | Buffer 4 | Less than 75% | HMF and HMG are ON | |
| | | Between 75% | HMF is ON. HMG is | |
| | | and 99% | OFF | |
| | | Larger than | HMF and HMG are OFF | |
| | | 99% | | |
| ASSY | Completed | Larger than | ASSY is OFF | Other- |
| | Product | 450 | | wise, |
| | | | | check |
| | | | | Buffer 4 |
| | Buffer 4 | Larger than | ASSY is ON | |
| | | 25% | | |
| | | Not larger than | ASSY is OFF | |
| | | 25% | | |

TABLE VI
OPTIMAL THRESHOLD VALUES AND CONTROL STRATEGIES
FOR COST-ORIENTED OBJECTIVE

| Pro- | | | | |
|---|---|---|---|---|
| cess | Buffer | Condition | Action | Others |
| RM | Buffer 1 | Less than 67% | RMA, RMB, | |
| | | | and RMC are | |
| | | | ON | |
| | | Between 67% | RMA and RMC | |
| | | and 80% | are ON. RMB is | |
| | | | OFF | |
| | | Between 80% | RMC is ON. | |
| | | and 99% | RMA and RMB | |
| | | | are OFF | |
| | | Larger than | RMA, RMB, | |
| | | 99% | and RMC are | |
| | | | OFF | |
| SM | Buffer 2 | Less than 450 | SMD and SME | Other- |
| | | | are ON | wise, |
| | | | | check |
| | | | | Buffer 1 |
| | Buffer 1 | Less than 25% | SMD and SME | |
| | | | are OFF | |
| | | Between 25% | SMD is OFF | |
| | | and 46% | SME is ON | |
| | | Larger than | SMD and SME | |
| | | 26% | are ON | |
| HM | Buffer 4 | Less than 58% | HMF and HMG | |
| | | | are ON | |
| | | Between 58% | HMF is ON. | |
| | | and 99% | HMG is OFF | |
| | | Larger than | HMF and HMG | |
| | | 99% | are OFF | |
| ASSY | Completed | Larger than 450 | ASSY is OFF | Other- |
| | Product | | | wise, |
| | | | | check |
| | | | | Buffer 4 |
| | Buffer 4 | Larger than | ASSY is ON | |
| | | 31% | | |
| | | Not larger than | ASSY is OFF | |
| | | 31% | | |

Optimal threshold values and corresponding control actions for each station for cost-oriented and energy-oriented objectives are Obtained using a GA and are shown in Table VI and Table VII, respectively. Information regarding the computer system used to implement the GA is as follows: Intel(R) Core™2 Quad CPU Q9650 @3.00 GHz 2.99 GHz processor, 8.00 GB memory and a 64 bit operating system. The number of generations in the GA is 50 and the size of each generation is 10. The computational time is approximately 48 minutes.

TABLE VII
OPTIMAL THRESHOLD VALUES AND CONTROL STRATEGIES
FOR ENERGY-ORIENTED OBJECTIVE

| Pro- | | | | |
|---|---|---|---|---|
| cess | Buffer | Condition | Action | Others |
| RM | Buffer 1 | Less than 59% | RMA, RMB, and RMC | |
| | | | are ON | |
| | | Between 59% | RMA and RMC are ON. | |
| | | and 72% | RMB is OFF | |
| | | Between 72% | RMC is ON. RMA and | |
| | | and 89% | RMB are OFF | |
| | | Larger than | RMA, RMB, and RMC | |
| | | 89% | are OFF | |
| SM | Buffer 2 | Less than 450 | SMD and SME are ON | Other- |
| | | | | wise, |
| | | | | check |
| | | | | Buffer 1 |
| | Buffer 1 | Less than 25% | SMD and SME are OFF | |
| | | Between 25% | SMD is OFF. SME is | |
| | | and 49% | ON | |
| | | Larger than | SMD and SME are ON | |
| | | 49% | | |
| HM | Buffer 4 | Less than 51% | HMF and HMG are ON | |
| | | Between 51% | HMF is ON. HMG is | |
| | | and 89% | OFF | |
| | | Larger than | HMF and HMG are OFF | |
| | | 89% | | |
| ASSY | Completed | Larger than | ASSY is OFF | Other- |
| | Product | 450 | | wise, |
| | | | | check |
| | | | | Buffer 4 |
| | Buffer 4 | Larger than | ASSY is ON | |
| | | 25% | | |
| | | Not larger than | ASSY is OFF | |
| | | 25% | | |

The results of production and energy consumption of the buffer-based control by using optimal threshold values obtained in step 1 of the two-step model are summarized in Table VIII.

In Step 2, we utilize the results obtained from Step 1 with two different objectives to implement the optimization. In this step, for each objective, we examine two different buffer utilization policies, i.e., empirical buffer policy, and extreme buffer policy. The bounds of the buffer for these two policies are illustrated in Table IX. The number of generations in GA is 50 and the size of each generation is 10. The computational time is approximately 49 minutes for each combination of objective-buffer policy pair.

TABLE VIII
IMPROVEMENT OF BUFFER BASED CONTROL MODEL

| | | Cost | Improve- | Energy- | Improve- |
|---|---|---|---|---|---|
| | Baseline | Oriented | ment | Oriented | ment |
| Electricity | 9566.4 | 8137.8 | 14.93% | 7676.4 | 19.76% |
| (kWh) | | | | | |
| Operational | 1457.8 | 1207.3 | 17.18% | 1089.4 | 25.27% |
| (KWh) | | | | | |
| Demand | 1382.8 | 1247.9 | 9.76% | 1262.31 | 8.71% |
| (kW) | | | | | |
| Cost ($) | 23389.17 | 21058.24 | 9.97% | | |
| Throughput | 521 | 456 | | 456 | |
| Heat | 450 | 450 | | 450 | |
| treatment | | | | | |

TABLE IX
BUFFER BOUNDS FOR TWO BUFFER POLICIES

| | Extreme Policy | Empirical Policy |
|---|---|---|
| Raw Material Buffer | 0-900 | 0-100 |
| Buffer 1 | 0-900 | 0-300 |
| Buffer 2 | 0-1000 | 300-900 |
| Buffer 3 | 0-1000 | 360-900 |
| Buffer 4 | 0-800 | 360-800 |

The results of the cost-oriented objective and the energy-oriented objective are shown in Table X and XI, respectively, In accordance with the invention, it can be seen that the energy consumption cost or energy consumption can be significantly reduced without influencing the production target.

TABLE X
IMPROVEMENT OF THE RESULTS
OF COST ORIENTED OBJECTIVE

| | | | Improve- | | Improve- |
|---|---|---|---|---|---|
| | Baseline | EX | ment | EM | ment |
| Electricity | 9566.4 | 4398.8 | 54.02% | 6578.9 | 31.23% |
| (kWh) | | | | | |
| Operational | 1457.8 | 741 | 49.17% | 991.1 | 32.01% |
| (KWh) | | | | | |
| Cost ($) | 23389.17 | 12724.35 | 45.60% | 17116.72 | 26.82% |
| Demand | 1382.8 | 766.22 | 44.59% | 1019.34 | 26.28% |
| (kW) | | | | | |
| Throughput | 521 | 505 | | 475 | |
| Heat | 450 | 450 | | 450 | |
| treatment | | | | | |

TABLE XI
IMPROVEMENT OF THE RESULTS OF
ENERGY ORIENTED OBJECTIVE

| | | | Improve- | | Improve- |
|---|---|---|---|---|---|
| | Baseline | EX | ment | EM | ment |
| Electricity | 9566.4 | 3472.8 | 63.70% | 6470.8 | 32.36% |
| (kWh) | | | | | |
| Operational | 1457.8 | 654.4 | 55.11% | 960.9 | 34.09% |
| (KWh) | | | | | |
| Demand | 1382.8 | 854.05 | 38.24% | 1254.5 | 9.28% |
| (kW) | | | | | |
| Throughput | 521 | 521 | | 475 | |
| Heat | 450 | 450 | | 450 | |
| treatment | | | | | |

The overall improvement using the two-step model 24 is illustrated in Table XII.

TABLE XII
OVERALL IMPROVEMENT USING THE TWO-STEP MODEL

| | | Electricity | Electricity | Power | | |
|---|---|---|---|---|---|---|
| | | Consumption | Consumption | Demand | Demand | Total Bill |
| Orientation | Model | (kWh) | Cost ($) | (kW) | Cost ($) | Cost ($) |
| Baseline | Baseline | 9566.40 | 2647.18 | 1382.80 | 20741.98 | 23389.17 |
| Model | Model | | | | | |
| Cost | Buffer | 8137.80 | 2339.77 | 1247.90 | 18718.47 | 21058.24 |
| Oriented | Based | | | | | |
| | Model | | | | | |
| | Reduction | 14.93% | 11.61% | 9.76% | 9.76% | 9.97% |
| | Scheduling | 4398.81 | 1231.03 | 766.22 | 11493.32 | 12724.35 |
| | with | | | | | |
| | Extreme | | | | | |
| | Buffer | | | | | |
| | Bound | | | | | |
| | Reduction | 54.02% | 53.50% | 44.59% | 44.59% | 45.60% |
| | Scheduling | 6578.87 | 1826.60 | 1019.34 | 15290.12 | 17116.72 |
| | with | | | | | |
| | Empirical | | | | | |
| | Buffer | | | | | |
| | Bound | | | | | |
| | Reduction | 31.23% | 31.00% | 26.28% | 26.28% | 26.82% |
| Energy | Buffer | 7676.45 | — | 1262.31 | — | — |
| Oriented | Based | | | | | |
| | Model | | | | | |
| | Reduction | 19.76% | — | 8.71% | — | — |
| | Scheduling | 3472.79 | — | 854.05 | — | — |
| | with | | | | | |
| | Extreme | | | | | |
| | Buffer | | | | | |
| | Bound | | | | | |
| | Reduction | 63.70% | — | 38.24% | — | — |
| | Scheduling | 6470.83 | — | 1254.50 | — | — |
| | with | | | | | |
| | Empirical | | | | | |
| | Buffer | | | | | |
| | Bound | | | | | |
| | Reduction | 32.36% | — | 9.28% | — | — |

The case study was also conducted with respect to the one-step model 26 described in relation to FIG. 2. The overall improvement using the one-step model 26 is illustrated in Table XIII.

TABLE XIII
OVERALL IMPROVEMENT USING THE ONE-STEP MODEL

| | | Electricity | Electricity | Power | | |
|---|---|---|---|---|---|---|
| | | Consumption | Consumption | Demand | Demand | Total Bill |
| Orientation | Model | (kWh) | Cost ($) | (kW) | Cost ($) | Cost ($) |
| Baseline | Baseline | 9566.40 | 2647.18 | 1382.80 | 20741.98 | 23389.17 |
| Model | Model | | | | | |
| Cost- | Scheduling | 3151.10 | 862.54 | 567.40 | 8510.98 | 9373.52 |
| Oriented | with | | | | | |
| | Extreme | | | | | |
| | Buffer | | | | | |
| | Bound | | | | | |
| | Reduction | 67.06% | 67.42% | 58.97% | 58.97% | 59.92% |
| | Scheduling | 6375.95 | 1760.63 | 979.33 | 14689.96 | 16450.58 |
| | with | | | | | |
| | Empirical | | | | | |
| | Buffer | | | | | |
| | Bound | | | | | |
| | Reduction | 33.35% | 33.49% | 29.18% | 29.18% | 29.67% |
| Energy- | Scheduling | 2078.75 | — | 634.93 | — | — |
| Oriented | with | | | | | |
| | Extreme | | | | | |
| | Buffer | | | | | |
| | Bound | | | | | |
| | Reduction | 78.27% | — | 54.08% | — | — |
| | Scheduling | 6364.32 | — | 1152.12 | — | — |
| | with | | | | | |
| | Empirical | | | | | |
| | Buffer | | | | | |
| | Bound | | | | | |
| | Reduction | 33.47% | — | 16.68% | — | — |

The current invention provides a simulation-based methodology for a production process that minimizes energy consumption or energy cost without sacrificing production targets. In particular, detailed production schedules for each station on a production line are generated thus minimizing energy consumption or energy cost. The current invention may be used to enhance the functionality of an existing energy management system and/or implemented in a commercial Manufacturing Execution System (MES). Further, the current invention provides an energy-integrated production scheduling tool for an industrial plant.

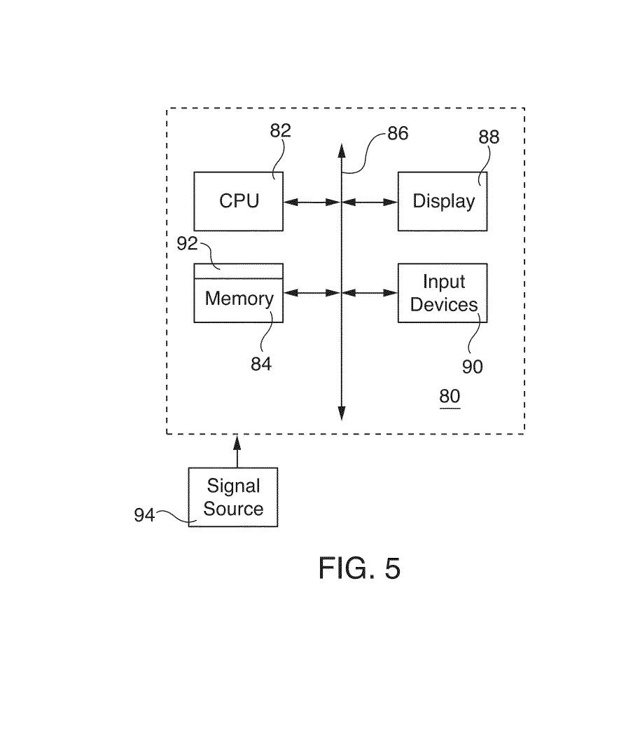

The current invention may be implemented by using a computer. A high level block diagram of a computer 80 is illustrated in FIG. 5. The computer 80 includes software and drivers for performing the simulation of the current invention. The computer 80 may use well-known computer processors, memory units, storage devices, computer software, and other components. Computer 80 may include a central processing unit (CPU) 82, a memory 84 and an input/output (I/O) interface 86. The computer 80 is generally coupled through the I/O interface 86 to a display 88 for visualization and various input devices 90 that enable user interaction with the computer 80 such as a keyboard, keypad, touchpad, touchscreen, mouse, speakers, buttons or any combination thereof. Support circuits may include circuits such as cache, power supplies, clock circuits, and a communications bus. The memory 84 may include random access memory (RAM), read only memory (ROM), disk drive, tape drive, etc., or a combination thereof. Embodiments of the present disclosure may be implemented as a routine 92 that is stored in memory 84 and executed by the CPU 82 to process the signal from a signal source 94. As such, the computer 80 is a general purpose computer system that becomes a specific purpose computer system when executing the routine 92. The computer 80 can communicate with one or more networks such as a local area network (LAN), a general wide area network (WAN), and/or a public network (e.g., the Internet) via a network adapter. One skilled in the art will recognize that an implementation of an actual computer could contain other components as well, and that FIG. 5 is a high level representation of some of the components of such a computer for illustrative purposes.

The computer 80 also includes an operating system and micro-instruction code. The various processes and functions described herein may either be part of the micro-instruction code or part of the application program (or a combination thereof) which is executed via the operating system. In addition, various other peripheral devices may be connected to the computer platform such as an additional data storage device and a printing device. Examples of well-known computing systems, environments, and/or configurations that may be suitable for use with computer 80 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

The system and processes of the figures are not exclusive. Other systems, processes and menus may be derived in accordance with the principles of the invention to accomplish the same objectives. Although this invention has been described with reference to particular embodiments, it is to be understood that the embodiments and variations shown and described herein are for illustration purposes only. Modifications to the current design may be implemented by those skilled in the art, without departing from the scope of the invention. As described herein, the various systems, subsystems, agents, managers and processes can be implemented using hardware components, software components, and/or combinations thereof.

What is claimed is:

1. A method for optimizing production scheduling in a manufacturing plant having a plurality of stations and buffers, comprising:
providing a baseline simulation model of the manufacturing plant to obtain energy and production performance of each station;
providing a buffer based control scheme that generates at least one optimal buffer threshold value and a first production schedule; and
generating a final production schedule by utilizing extreme and empirical buffer utilization policies.

2. The method according to claim 1, wherein the buffer based control scheme utilizes a genetic algorithm having a first fitness function that includes an electricity consumption minimization objective and a second fitness function that includes an electricity cost minimization objective.

3. The method according to claim 2, the first and second fitness functions each include a penalty for violating a production throughput constraint.

4. The method according to claim 1, wherein the buffer threshold value is a ratio of a buffer level to a buffer capacity.

5. The method according to claim 1, wherein the buffer based control scheme is used to temporarily stop production when an upstream buffer is empty or approximately empty or a downstream buffer is full or approximately full.

6. The method according to claim 1, wherein the buffer based control scheme is used to maintain production when an upstream buffer is full or approximately full or a downstream buffer is empty or approximately empty.

7. The method according to claim 1, wherein a buffer level for the extreme buffer utilization policy can vary from zero to full capacity.

8. The method according to claim 1, wherein in the empirical buffer policy a range of safety stock is available in the buffer.

9. A method for optimizing production scheduling in a manufacturing plant having a plurality of stations and buffers, comprising:
providing a baseline simulation model of the manufacturing plant to obtain energy and production performance of each station;
providing a buffer based control scheme that generates at least one optimal buffer threshold value and a first production schedule, wherein the buffer based control scheme utilizes a genetic algorithm having first and second fitness functions each including a penalty for violating a production throughput constraint and wherein the first fitness function includes an electricity consumption minimization objective and the second fitness function includes an electricity cost minimization objective; and
generating a final production schedule by utilizing a genetic algorithm having third and fourth fitness functions each having a penalty for violating an extreme buffer utilization policy and the penalty for violating the production throughput constraint and wherein the genetic algorithm includes fifth and sixth fitness functions each having a penalty for violating an empirical buffer utilization policy and the penalty for violating the production throughput constraint wherein the third and fifth fitness functions each include the electricity consumption minimization objective and the fourth and sixth fitness functions each include the electricity cost minimization objective.

10. The method according to claim 9, wherein the buffer based control scheme is used to temporarily stop production when an upstream buffer is empty or approximately empty or a downstream buffer is full or approximately full.

11. The method according to claim 9, wherein the buffer based control scheme is used to maintain production when an upstream buffer is full or approximately full or a downstream buffer is empty or approximately empty.

12. The method according to claim 9, wherein the extreme buffer utilization policy provides that a buffer level ranges between zero and full capacity.

13. The method according to claim 9, wherein the empirical buffer utilization policy provides that a minimum and maximum number of parts be available in a buffer.

14. The method according to claim 9, wherein the buffer threshold value is a ratio of a buffer level to a buffer capacity.

15. The method according to claim 14, wherein an initial buffer threshold value is between approximately 0.5 and 1.0 when used to control an upstream station.

16. The method according to claim 14, wherein an initial threshold value is between approximately 0 and 0.5 when used to control a downstream station.

17. The method according to claim 9, wherein the first production schedule includes a scheduling unit that is approximately equivalent to a time interval used by an electric utility to calculate a power demand charge.

18. A method in a computer system for optimizing production scheduling in a manufacturing plant having a plurality of stations and buffers, comprising:
providing a baseline simulation model of the manufacturing plant to obtain energy and production performance of each station; and
generating a final production schedule by utilizing a genetic algorithm having
first and second fitness functions each having a penalty for violating the extreme buffer utilization policy and a penalty for violating a production throughput constraint and
the genetic algorithm includes third and fourth fitness functions that include a penalty for violating the empirical buffer utilization policy and the penalty for violating the production throughput constraint
wherein the first and third fitness functions each include an electricity consumption minimization objective and
the second and fourth fitness functions each include an electricity cost minimization objective.

19. The method according to claim 18, wherein the extreme buffer utilization policy provides that a buffer level ranges between zero and full capacity.

20. The method according to claim 18, wherein the empirical buffer utilization policy provides that a minimum and maximum number of parts be available in a buffer.
